(19) United States
(12) Patent Application Publication
(10) Pub. No.: US 2012/0229925 A1
(43) Pub. Date: Sep. 13, 2012

(54) LENS DRIVING DEVICE

(75) Inventors: KENICHI MORIO, Okayama (JP); HIDEKI SHIGEMOTO, Okayama (JP)

(73) Assignee: PANASONIC CORPORATION, Osaka (JP)

(21) Appl. No.: 13/409,420

(22) Filed: Mar. 1, 2012

(30) Foreign Application Priority Data
Mar. 7, 2011 (JP) 2011-048700

(51) Int. Cl. G02B 7/02

(52) U.S. Cl. 359/824

(57) ABSTRACT

A lens driving device includes a box-shaped yoke, a tubular carrier, a coil, a magnet, and a base. The carrier has a first opening in which a lens can be installed. The carrier is held in the yoke for moving from a top dead point to a bottom dead point. The coil is provided on an outer periphery of the carrier. The magnet is provided facing the coil. The base has a second opening on its bottom, and is provided adjacent to the carrier at a side of the moving direction of the carrier. The base has a tubular protrusion formed protruding upward from an outer periphery of its second opening. The tubular protrusion overlaps with the carrier in a direction perpendicular to the moving direction of the carrier wherever the carrier moves between the top dead point and the bottom dead point.

### BACKGROUND

1. Technical Field

The technical field relates to lens driving devices employed typically in small cameras installed in apparatuses such as mobile phones.

2. Background Art

Many mobile phones are now equipped with a small camera. A lens driving device used in this small camera is described below with reference to the drawings.

FIG. 6 is a sectional view of a conventional lens driving device. FIG. 7 is an exploded perspective view of the conventional lens driving device. The conventional lens driving device includes base 1, lower springs 2 and 3, carrier 7, coil 5, magnet 6, upper spring 8, and yoke 9.

Base 1 is rectangular when seen from the top, and is formed of an insulating resin. A center hole is created on the bottom of base 1. Projection 1A protruding upward is formed at each bottom corner of base 1.

Each of lower springs 2 and 3 has a terminal extending downward, and is placed on a top face of the bottom of base 1. Each of lower springs 2 and 3 has holding parts 2A and 3A. Projections 1A of base 1 are inserted into caulking holes provided on holding parts 2A and 3A, and upper ends of projections 1A are caulked. This makes lower springs 2 and 3 fixed onto base 1. Lower springs 2 and 3 also have arc portions 2B and 3B, respectively, extending from holding parts 2A and 3A via a resilient arm. Each of arc portions 2B and 3B has a caulking hole. Projections provided on a lower part of carrier 7 are inserted into caulking holes of arc portions 2B and 3B, respectively, and lower ends of the projections are caulked. This makes arc portions 2B and 3B fixed onto carrier 7.

Carrier 7 has multiple legs 7A protruding downward. Lower end faces of legs 7A make contact with the top face of the bottom of base 1.

Coil 5 is provided on an outer periphery of carrier 7. A starting end and termination end of a coil wire configuring coil 5 are connected to lower springs 2 and 3, respectively.

Yoke 9 is a box-shaped rectangular with an opening at its lower part, when seen from the top, and is formed of a magnetic metal plate. A hole is provided at the center of the top face of yoke 9. Step 9A that is slightly lowered is formed over the entire periphery of the top face of yoke 9.

Metal upper spring 8 and substantially-cuboid magnet 6 are disposed in yoke 9, respectively. Magnet 6 is bonded onto an inner side face of yoke 9. Outer periphery 8A of upper spring 8 is positioned and fixed between an undersurface of step 9A and the top face of magnet 6 in yoke 9. The South pole (or North pole) of each of magnets 6 is directed toward external side wall of yoke 9.

Yoke 9 houses carrier 7 including coil 5, and is fixed onto the outer side face of base 1 by an adhesive. In this state, the outer side face of coil 5 on carrier 7 and the inner side face of magnet 6 face each other with a predetermined space in between. Upper spring 8 has inner periphery 8B extending from outer periphery 8A via the resilient arm. Inner periphery 8B is bonded onto the upper part of carrier 7.

In the conventional lens driving device as configured above, a lens unit (not illustrated) is installed in carrier 7, and is positioned to an image pickup element (not illustrated) for use.

Next, the operation is described. When power is applied to coil 5 via the terminal of lower springs 2 and 3, the current travels in coil 5 in a circumferential direction of carrier 7. A magnetic flux from magnet 6 acts in a radial direction through coil 5. Therefore, the electromagnetic force acts on carrier 7, generating a force in a corresponding vertical direction, i.e., an optical axis direction. This makes carrier 7 and the lens unit in carrier 7 move in the optical axis direction against spring forces of upper spring 8 and lower springs 2 and 3, and stop at a position where these spring forces are balanced. In this way, the lens unit comes into focus by controlling the amount of current supplied to coil 5.

Prior art includes the Japanese Patent Unexamined Publication No. 2008-116620.

However, the conventional lens driving device is configured such that legs 7A of carrier 7 make contact with the bottom surface of base 1 when the lens driving device is not activated and carrier 7 stays at the lowest position, a so-called bottom dead point. If dust enters around carrier 7, this dust reaches an imaging area of image pickup element through a gap at legs 7A of carrier 7, as shown by an arrow in FIG. 6. Dust entering in this way may degrade the quality of images captured.

### SUMMARY

A lens driving device of an embodiment includes a box-shaped yoke, a tubular carrier, a coil, a magnet, and a base. The carrier has a first opening in which a lens can be installed, and is held in the yoke for moving from a top dead point to a bottom dead point. The coil is provided on an outer periphery of the carrier. The magnet is provided facing a winding face of the coil. The base has a second opening on its bottom face, and is provided adjacent to the carrier at a side of the moving direction of the carrier. The base has a tubular protrusion protruding upward from an outer periphery of the second opening. The tubular protrusion overlaps with the carrier in a direction perpendicular to the moving direction of the carrier wherever the carrier moves between the top dead point and the bottom dead point.

The above configuration can prevent entry of dust into an image pickup element even if the carrier with lens unit is in the non-active state or vertically-moved state. The embodiment thus offers the lens driving device that can capture quality images.

### BRIEF DESCRIPTION OF THE DRAWINGS

FIG. 1 is a sectional view of a lens driving device when its carrier is positioned at a bottom dead point in accordance with an exemplary embodiment.

FIG. 2 is an exploded perspective view of the lens driving device in accordance with the exemplary embodiment.

FIG. 3 is a perspective view of the lens driving device when its carrier is seen from the bottom in accordance with the exemplary embodiment.

FIG. 4 is a sectional view of the lens driving device when its carrier is positioned at a top dead point in accordance with the exemplary embodiment.

FIG. 5 is a sectional view of another lens driving device when its carrier is positioned at the top dead point in accordance with the exemplary embodiment.

FIG. 6 is a sectional view of a conventional lens driving device.

FIG. 7 is an exploded perspective view of the conventional lens driving device.

### DETAILED DESCRIPTION

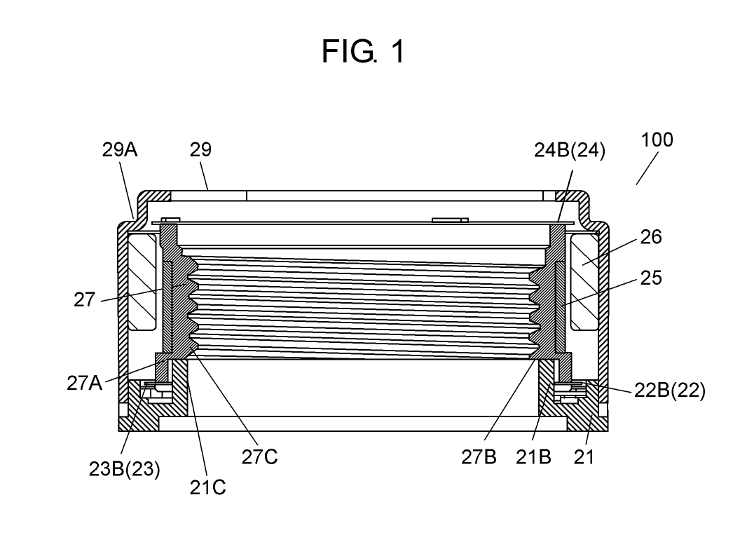

An exemplary embodiment is described below with reference to FIGS. 1 to 4.

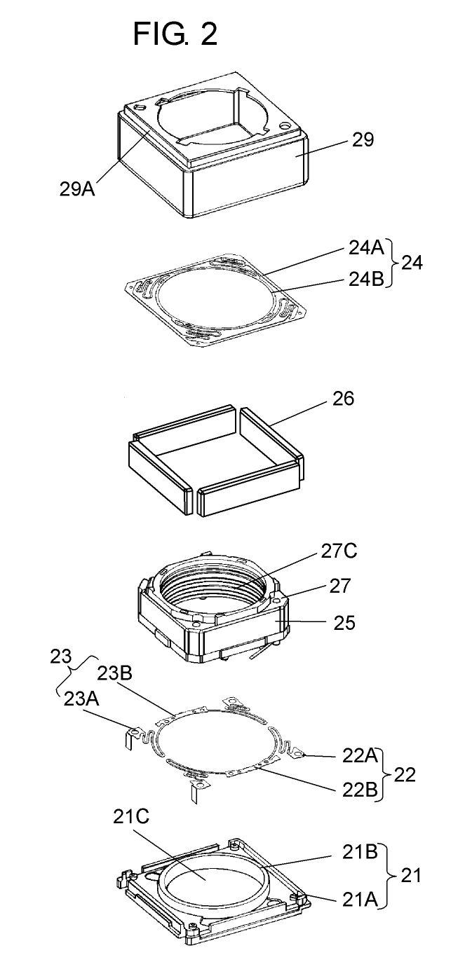

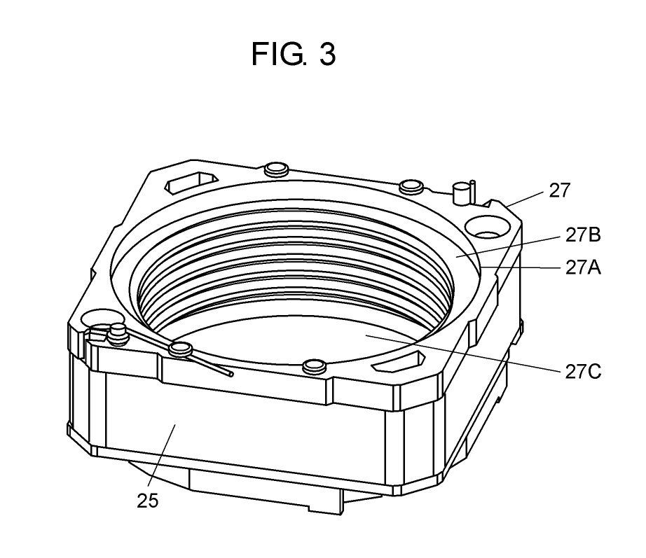

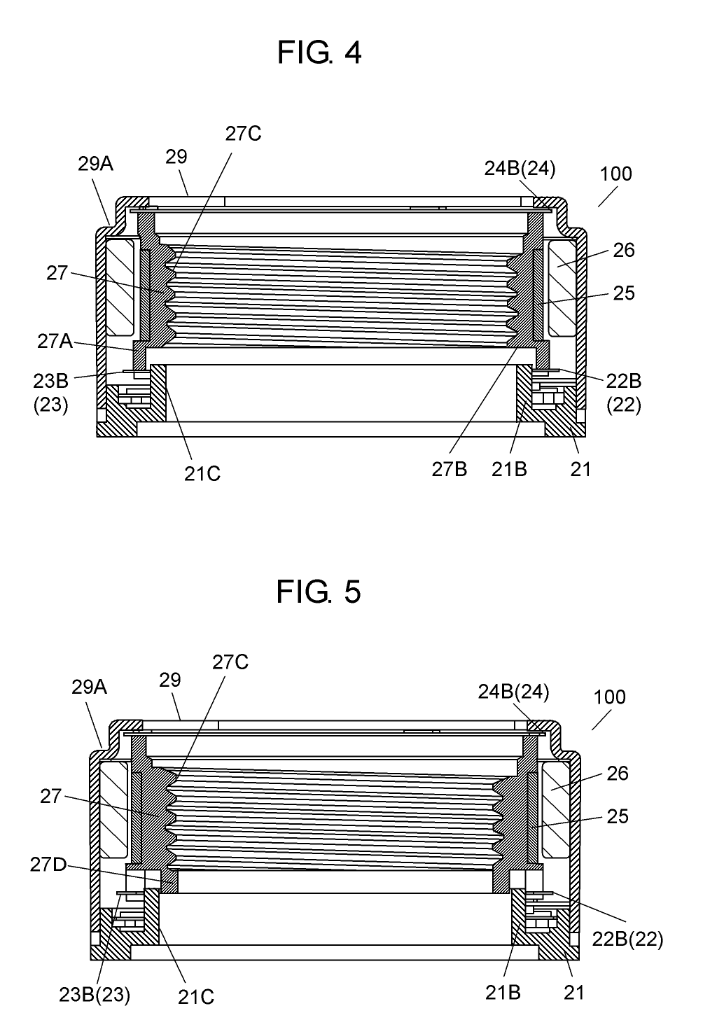

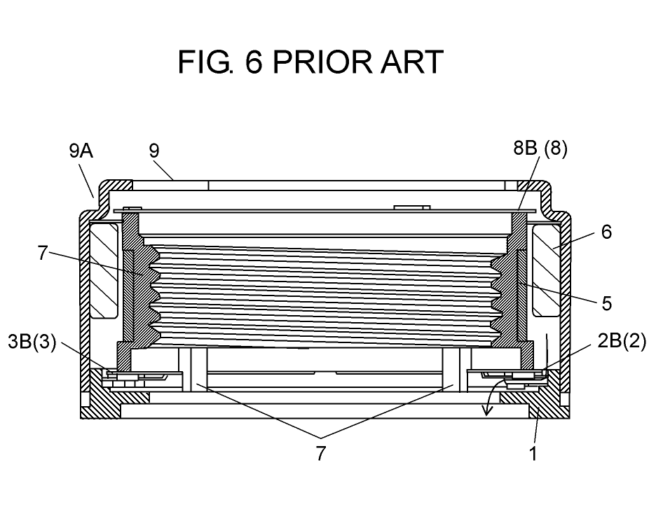

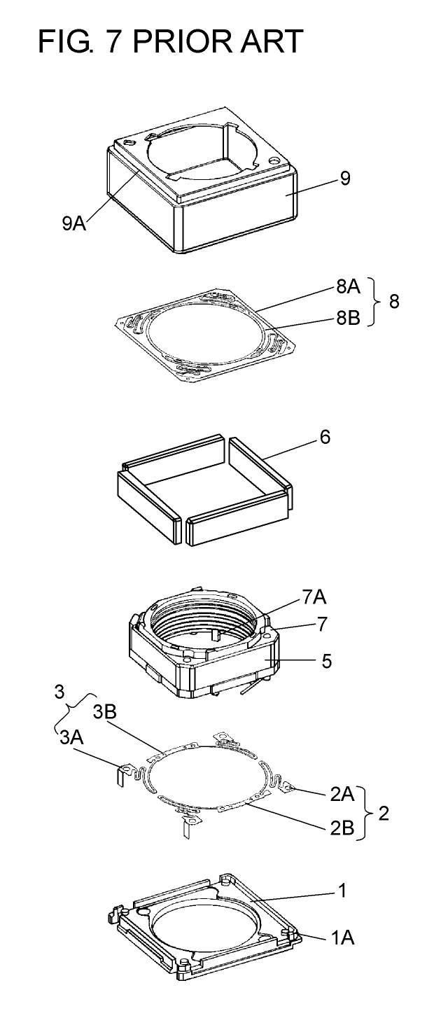

FIG. 1 is a sectional view of a lens driving device in the exemplary embodiment when its carrier is positioned at a bottom dead point. FIG. 2 is an exploded perspective view of the lens driving device in the exemplary embodiment when its carrier is positioned at a bottom dead point. FIG. 3 is a perspective view of the lens driving device in the exemplary embodiment when its carrier is seen from the bottom. FIG. 4 is a sectional view of the lens driving device in the exemplary embodiment when its carrier is positioned at a top dead point.

Lens driving device 100 includes yoke 29, carrier 27, coil 25, magnet 26, and base 21. Yoke 29 is box shaped, and its lower part is open. Yoke 29 also has a round hole on its top face. Carrier 27 is tubular, and has opening 27C (first opening) in which a lens (not illustrated) can be installed. Carrier 27 is held in yoke 29 such that it can be vertically moved between a top dead point and a bottom dead point. Coil 25 is provided on an outer periphery of carrier 27. Magnet 26 is provided facing a winding face of coil 25. Base 21 is provided beneath carrier 27, and has opening 21C (second opening) on its bottom face. Base 21 has ring-shaped tubular protrusion 21B protruding upward from an outer rim of opening 21C.

Base 21 is rectangular when seen from the top, and is formed of insulating resin. Projection 21A protruding upward is formed at each bottom corner of base 21. Metal lower springs 22 and 23 with terminals extending downward are placed on the top face of the bottom of base 21. Lower springs 22 and 23 have holding parts 22A and 23A with caulking holes, respectively. Projections 21A are inserted to holding parts 22A and 23A, respectively, and top ends of projections are caulked to fix base 21. Lower springs 22 and 23 have arc portions 22B and 23B extending from holding parts 22A and 23A via resilient arms. Each of arc portions 22B and 23B has a caulking hole.

Carrier 27 has a slightly larger inner diameter than an outer diameter of tubular protrusion 21B of base 21, and has annular recess 27A on its bottom face. Annular recess 27A is formed around opening 27C. The bottom face of carrier 27 has projections, and these projections are inserted into the caulking holes of arc portions 22B and 23B to fix carrier 27.

The top end of tubular protrusion 21B of base 21 overlaps with carrier 27 in a direction perpendicular to a moving direction of carrier 27, i.e., the vertical direction. In this exemplary embodiment, carrier 27 houses an upper part of tubular protrusion 21B in annular recess 27A, and the top end face of tubular protrusion 21B makes contact with stopper 27B, which is a flat bottom face of annular recess 27A. In other words, the flat bottom face of annular recess 27A vertically facing the top end face of tubular protrusion 21B acts as stopper 27B.

A starting end and termination end of coil wire configuring coil 25 are connected to lower springs 22 and 23, respectively.

Yoke 29 has a rectangular box shape when seen from the top, and is formed of a metal plate. The lower part of yoke 29 is opened. Yoke 29 also has a hole at the center of its top face. In addition, step 29A that is a portion slightly lowered is formed over the entire outer periphery of the top face of yoke 29. Metal upper spring 24 and substantially cuboid magnet 26 are disposed inside yoke 29. Magnet 26 is bonded and fixed onto an inner side wall of yoke 29. Outer periphery 24A of upper spring 24 is positioned and fixed by being sandwiched between an undersurface of step 29A of yoke 29 and the top face of magnet 26. With respect to magnetic pole of each magnet 26, South pole (or North pole) faces toward the winding face of coil 25. Yoke 29 houses carrier 27, and is bonded and fixed onto an outer side face of base 21. In this state, the outer side face of coil 25 provided on carrier 27 and the inner side face of magnet 26 face each other with a predetermined space in between. Upper spring 24 has inner periphery 24B extending from outer periphery 24A via a resilient arm. Inner periphery 24B is fixed onto an upper part of carrier 27.

In lens driving device 100 in the exemplary embodiment as configured above, the lens unit is installed in carrier 27 for use, and the lens unit is positioned to the image pickup element.

Next is described the operation of the lens driving device in this exemplary embodiment. In the state that current is not applied to coil 25, i.e., non-active state, carrier 27 is positioned at the lowest end, a so-called bottom dead point, by the downward spring force of lower springs 22 and 23 and upper spring 24.

At this point, the top end of tubular protrusion 21B of base 21 is inserted in the lower part of carrier 27. In other words, as described above, stopper 27B and the top end of tubular protrusion 21B of base 21 make contact over the entire periphery, and the top end of tubular protrusion 21B is inserted in carrier 27. More specifically, the top outer face of tubular protrusion 21B is inserted inside annular recess 27A of carrier 27. Accordingly, there is no room for dust to enter between carrier 27 and base 21. Dust cannot reach inside carrier 27 or an imaging face of the image pickup element.

In the exemplary embodiment, tubular protrusion 21B is formed in uniform height over the entire periphery. In addition, stopper 27B and the top end of tubular protrusion 21B of base 21 make contact over the entire periphery. However, such configuration is not necessary for the entire periphery. For example, a configuration in which an air vent clearance may be provided partially, and thus a part of the top end of tubular protrusion 21B does not make contact with stopper 27B may be acceptable. As long as the top outer face of tubular protrusion 21B is inserted inside annular recess 27A over the entire periphery, other configurations are also acceptable.

With consideration to an assembly error, the bottom end of carrier 27 does not preferably make contact with the bottom surface of base 21 in this state. More specifically, a height of tubular protrusion 21B is preferably greater than a depth of annular recess 27A.

Next, when power is applied to coil 25 through the terminals of lower springs 22 and 23, current travels in coil 25 along the outer periphery of carrier 27. Here, magnetic flux from magnet 26 acts in a radial direction through coil 25. Therefore, the electromagnetic force acts on carrier 27, and a force in the vertical direction, i.e., the optical axis direction, is generated, depending on the direction of current. This force moves carrier 27 and the lens unit installed in it in the optical axis direction against the spring forces of upper spring 24 and lower springs 22 and 23. Carrier 27 stops at the position where these spring forces are balanced.

In this way, when carrier 27 moves upward, stopper 27B and the top end of tubular protrusion 21B, which were attached in the non-active state, separate. However, the depth of annular recess 27A and the height of tubular protrusion 21B are set such that the top outer face of tubular protrusion 21B remains covered by annular recess 27A. In other words, the top end of tubular protrusion 21B stays inside carrier 27 also while lens driving device 100 is activated. Accordingly, even in the active state, entry of dust into the imaging face of the image pickup element is preventable.

As shown in FIG. 3, the depth of annular recess 27A and the height of tubular protrusion 21B are preferably set such that the top end of tubular protrusion 21B remains inserted inside annular recess 27A in the state that carrier 27 is moved to the uppermost position, i.e., the top dead point. In other words, the bottom end of carrier 27 is preferably set to a position lower than the top outer face of tubular protrusion 21B over the entire periphery.

As described above, lens driving device 100 in the exemplary embodiment has tubular protrusion 21B overlapped with carrier 27 in a direction perpendicular to the moving direction of carrier 27 wherever carrier 27 moves between the top dead point and the bottom dead point. This prevents entry of dust as far to the imaging face of the image pickup element in both non-active and active states.

In the exemplary embodiment, as shown in FIGS. 1 and 4, tubular protrusion 21B is inserted into annular recess 27A. However, the embodiment is not limited to this configuration. The same effect is achievable with other configurations in which tubular protrusion 21B overlaps with carrier 27 in the direction perpendicular to the moving direction of carrier 27. For example, as shown in FIG. 5, tubular protrusion 27D protruding downward is formed on the bottom face of carrier 27, and the outer diameter of tubular protrusion 27D is made smaller than the inner diameter of tubular protrusion 21B. The bottom end of tubular protrusion 27D is inserted inside tubular protrusion 21B when carrier 27 moves to any position between the top dead point and bottom dead point.

In the above description, a terminal extending downward is provided on each of lower springs 22 and 23. In addition, a tip of coil wire of coil 25 is connected to arc portions 22B and 23B of lower springs 22 and 23. However, to further strengthen the terminal, the terminal may be independently formed with a metal plate thicker than that of the lower spring, and this may be connected to the lower spring.

Furthermore, the exemplary embodiment refers to the configuration of holding outer periphery 24A of upper spring 24 between the undersurface of step 29A of yoke 29 and the top face of magnet 26. However, the top face of yoke 29 may not have step 29A, and a spacer with thickness corresponding to the height of step 29A may be provided instead of the undersurface of step 29A. This spacer may be disposed inside yoke 29. In other words, outer periphery 24A of upper spring 24 may be held between the bottom face of the spacer and the top face of magnet 26.

Terms indicating directions, such as ‘vertical’ in the above description are used simply for describing relative positional relationship among components, and thus they do not specify absolute positions of the components.

### REFERENCE MARKS IN THE DRAWINGS

1 Base

1A Projection

2, 3 Lower spring

2A, 3A Holding part

2B, 3B Arc portion

5 Coil

6 Magnet

7 Carrier

7A Leg

8 Upper spring

8A Outer periphery

8B Inner periphery

9 Yoke

9A Step

21 Base

21A Projection

21B Tubular protrusion

21C Opening

22, 23 Lower spring

22A, 23A Holding part

22B, 23B Arc portion

24 Upper spring

24A Outer periphery

24B Inner periphery

25 Coil

26 Magnet

27 Carrier

27A Annular recess

27B Stopper

27C Opening

27D Tubular protrusion

29 Yoke

29A Step

100 Lens driving device

What is claimed is:

1. A lens driving device comprising:
a box-shaped yoke;
a tubular carrier with a first opening in which a lens can be installed, the tubular carrier being held in the yoke for moving from a top dead point to a bottom dead point;
a coil provided on an outer periphery of the tubular carrier;
a magnet provided facing the coil; and
a base with a second opening on its bottom face, the base being provided adjacent to the tubular carrier at a side of the moving direction of the tubular carrier;
wherein
the base has a tubular protrusion protruding from an outer periphery of the second opening toward the tubular carrier; and
the tubular protrusion overlaps with the tubular carrier in a direction perpendicular to the moving direction of the tubular carrier wherever the tubular carrier moves between the top dead point and the bottom dead point.

2. The lens driving device of claim 1,
wherein
a top end of the tubular protrusion remains inserted in the tubular carrier wherever the carrier moves between the top dead point and the bottom dead point.

3. The lens driving device of claim 1,
wherein
the tubular carrier has an inner diameter greater than an outer diameter of the tubular protrusion, and has an annular recess formed around the first opening on a bottom face of the tubular carrier; and
the top end of the tubular protrusion remains inserted in the annular recess wherever the tubular carrier moves between the top dead point and the bottom dead point.

4. The lens driving device of claim 3,
wherein
a bottom end of the annular recess is positioned lower than the top end of the tubular protrusion when the tubular carrier is positioned at the top dead point.

5. The lens driving device of claim 3,
wherein
a flat bottom of the annular recess is brought into contact with a top outer face of the tubular protrusion when the tubular carrier is positioned at the bottom dead point.

6. The lens driving device of claim 3,
wherein
a height of the tubular protrusion is greater than a depth of the annular recess.

7. The lens driving device of claim 1,
wherein
the tubular protrusion is formed with a uniform height over an entire outer periphery of the second opening.

8. A lens driving device comprising:
a yoke;
a tubular carrier including a first opening in which a lens can be disposed and having an annular recess disposed at an end portion, the tubular carrier being disposed in the yoke and configured to move between first and second dead points;
a coil provided on an outer periphery of the tubular carrier;
a magnet provided facing the coil; and
a base including a second opening on a bottom face, the base being disposed adjacent to the end portion of the tubular carrier;
wherein
the base has a tubular protrusion extending from an outer periphery of the second opening toward the end portion of the tubular carrier; and
at least a portion of the tubular protrusion is positioned within the annular recess of the tubular carrier wherever the tubular carrier moves between the first and second dead points.

9. The lens driving device of claim 8, wherein
the tubular protrusion is formed with a uniform height over the entire periphery of the second opening of the base.
